(19) United States
(12) Patent Application Publication
(10) Pub. No.: US 2007/0127028 A1
(43) Pub. Date: Jun. 7, 2007

(54) Optical measuring device

(75) Inventors: Katsuaki Kano, Matsuyama-shi (JP); Hajime Abe, Matsuyama-shi (JP); Yusuke Hamada, Matsuyama-shi (JP)

Correspondence Address: BIRCH STEWART KOLASCH & BIRCH, PO BOX 747, FALLS CHURCH, VA, 22040-0747, US

(73) Assignee: Miura Co., Ltd.

(21) Appl. No.: 11/598,693

(22) Filed: Nov. 14, 2006

(30) Foreign Application Priority Data
Dec. 1, 2005 (JP) 2005-347405

(51) Int. Cl. G01N 21/05

(52) U.S. Cl. 356/440

(57) ABSTRACT

The present invention realizes a compact optical measuring device in which a sample solution sampling mechanism and a cleaning fluid producing mechanism are integrated with each other. Provided is an optical measuring device which applies light from a light emitting element to a sample solution in a measuring chamber provided in a measuring cell through a first light guide portion and which detects light from the sample solution by a light receiving element through a second light guide portion, including: a flow passage section formed in the measuring cell and adapted to guide the sample solution into or out of the measuring chamber; a flow control section attached to the measuring cell and serving to open and close the flow passage section; and a filtering section connected to the measuring cell and communicating with the measuring chamber.

### BACKGROUND OF THE INVENTION

1. Field of the Invention

The present invention relates to an optical measuring device which applies light from a light emitting element to a sample solution in a measuring chamber provided in a measuring cell through a first light guide portion, and which detects light from the sample solution by a light receiving element through a second light guide portion.

2. Description of the Related Art

In order to measure the concentration of a specific component in water, such as suspended matter, hardness component, dissolved oxygen, and residual chlorine, scattered light detecting type and transmitted light detecting type optical measuring devices are widely used. Generally, those optical measuring devices stores sample water in a measuring cell provided with a pair of light transmitting windows. Light from a light emitting element is applied to the sample water through one light transmitting window, and light from the sample water is detected by a light receiving element through the other light transmitting window.

In a measuring operation, the optical measuring devices usually correct the intensity of the light from the sample water (i.e., transmitted light intensity or scattered light intensity) using the intensity of light from clean blank water (i.e., transmitted light intensity or scattered light intensity), whereby zero-point drift generated through contamination of the light transmitting windows, fluctuations in ambient temperature, etc. is canceled, thereby securing a predetermined measuring accuracy. Thus, as disclosed in JP 08-178913 A, in the optical measuring devices, a filter is provided in a water intake system, and clean water (i.e., blank water) is produced on-site.

Further, in the optical measuring devices, when the sample water contains a contaminant component, such as a colloidal substance or an organic substance, such the contaminant component adheres to the light transmitting windows, which may attenuate the quantity of light applied from the light emitting element and the quantity of light detected by the light receiving element, thereby substantially deteriorating the measuring accuracy. In particular, in the case of underground water, industrial water or the like, the sample water often contains a contaminant component, and the contamination of the light transmitting windows is likely to be promoted. In view of this, as proposed in JP 01-128150 U and JP 05-002055 U, in the optical measuring devices, clean washing water is ejected from a nozzle against the light transmitting windows, thus periodically recovering the light transmitting performance. In this connection, as disclosed in JP 01-128150 U, in the optical measuring devices, a filter is provided in the water intake system, and clean water (i.e., washing water) is produced on-site.

As disclosed in JP 08-178913 A, when a filter is provided in the water intake system for the purpose of light intensity correction and nozzle- washing the light transmitting windows with clean water, it is general practice to connect a bypass pipe to the sample water sampling pipe leading to the measuring cell and to provide the above-mentioned filter in the bypass pipe. Alternatively, as disclosed in JP 01-128150 U, it is also general practice to connect a water feed pipe for feeding tap water or the like to the sample water sampling pipe leading to the measuring cell and to provide the filter in the water feed pipe. In those constructions, however, the connection of the pipes and the like is complicated, and it is necessary to provide the pipes with a valve mechanism for switching between the sampling of sample water and the sampling of clean water. As a result, the optical measuring device, including the water intake system, becomes large, and it takes time to install the optical measuring device on-site, to perform maintenance thereon, and the like. Further, a flow passage from the filter to the nozzle becomes long; thus, due to a reduction in pressure, the amount of clean water ejected against the light transmitting windows per unit time is reduced, so there is a possibility of allowing the contaminant component to remain.

### SUMMARY OF THE INVENTION

The present invention has been made in view of the above-mentioned problems in the prior art. It is a first object of the present invention to realize a compact optical measuring device in which a sample solution sampling mechanism and a cleaning fluid producing mechanism are integrated with each other. It is a second object of the present invention to realize an optical measuring device capable of performing nozzle-washing without involving a reduction in the pressure with which the cleaning fluid is supplied.

The present invention has been made in order to attain the above-mentioned object. According to a first aspect of the present invention, there is provided an optical measuring device which applies light from a light emitting element to a sample solution in a measuring chamber provided in a measuring cell through a first light guide portion and which detects light from the sample solution by a light receiving element through a second light guide portion, the optical measuring device including: a flow passage section formed in the measuring cell and adapted to guide the sample solution into or out of the measuring chamber; a flow control section attached to the measuring cell and serving to open and close the flow passage section; and a filtering section connected to the measuring cell and communicating with the measuring chamber.

According to the first aspect of the present invention, the optical measuring device is equipped with the measuring cell constituting the sample solution measuring section, the flow passage section and the flow control section corresponding to the sample solution sampling mechanism, and the filtering section corresponding to the cleaning fluid producing mechanism. The flow passage section is formed in the measuring cell itself, the flow control section is attached to the measuring cell, and the filtering section is connected to the measuring cell. That is, in the optical measuring device, the sampling mechanism and the producing mechanism are integrally incorporated together with the measuring section, so the requisite mounting space is relatively small. Further, the optical measuring device can be used solely by being connected to predetermined sampling and drain lines.

Further, according to a second aspect of the present invention, there is provided an optical measuring device according to the first aspect, in which a nozzle for ejecting a cleaning fluid from the filtering section against the first light guide portion and the second light guide portion is provided in a communicating portion between the measuring chamber and the filtering section.

According to the second aspect of the present invention, the cleaning fluid produced in the filtering section is directly supplied to the nozzle without being passed through supply piping. Thus, the cleaning fluid from the filtering section reaches the nozzle without involving a reduction in pressure, so it is possible to maintain the flow velocity of the cleaning fluid ejected against the light guide portions within a predetermined range.

According to the present invention, there is realized a compact optical measuring device in which the sample solution sampling mechanism and the cleaning fluid producing mechanism are integrated with each other. Further, there is realized an optical measuring device capable of performing nozzle-washing without involving a reduction in the pressure with which the cleaning fluid is supplied. As a result, it is possible to perform installation of the device on-site, maintenance thereon, etc. in a short period of time. Further, it is possible to maintain a predetermined measuring accuracy by effectively removing the contaminant component adhering to the light transmitting windows.

### BRIEF DESCRIPTION OF THE DRAWINGS

In the accompanying drawings:

FIG. 1 is a full view of a turbidity measuring device according to a first embodiment of the present invention;

FIG. 2 is a sectional view taken along the line II-II of FIG. 1;

FIG. 3 is a view showing a liquid flow in the turbidity measuring device according to the first embodiment of the present invention;

FIG. 4 is a schematic view of a filtering system to which the turbidity measuring device according to the first embodiment of the present invention is connected;

FIG. 5 is a longitudinal sectional view of the turbidity measuring device according to the first embodiment of the present invention;

FIG. 6 is a sectional view taken along the line V-V of FIG. 1;

FIG. 7 is an explanatory view illustrating a first measuring process for the turbidity measuring device according to the first embodiment of the present invention;

FIG. 8 is an explanatory view illustrating a second measuring process for the turbidity measuring device according to the first embodiment of the present invention; and

FIG. 9 is an explanatory view illustrating a washing process for the turbidity measuring device according to the first embodiment of the present invention.

### DETAILED DESCRIPTION OF THE PREFERRED EMBODIMENTS

### First Embodiment

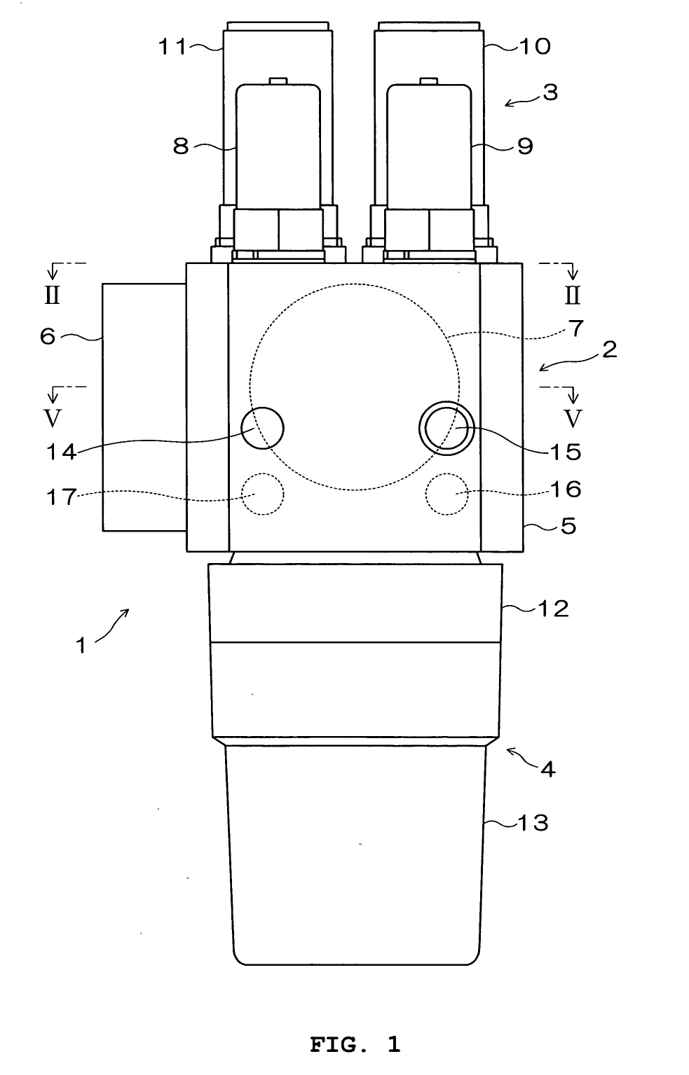

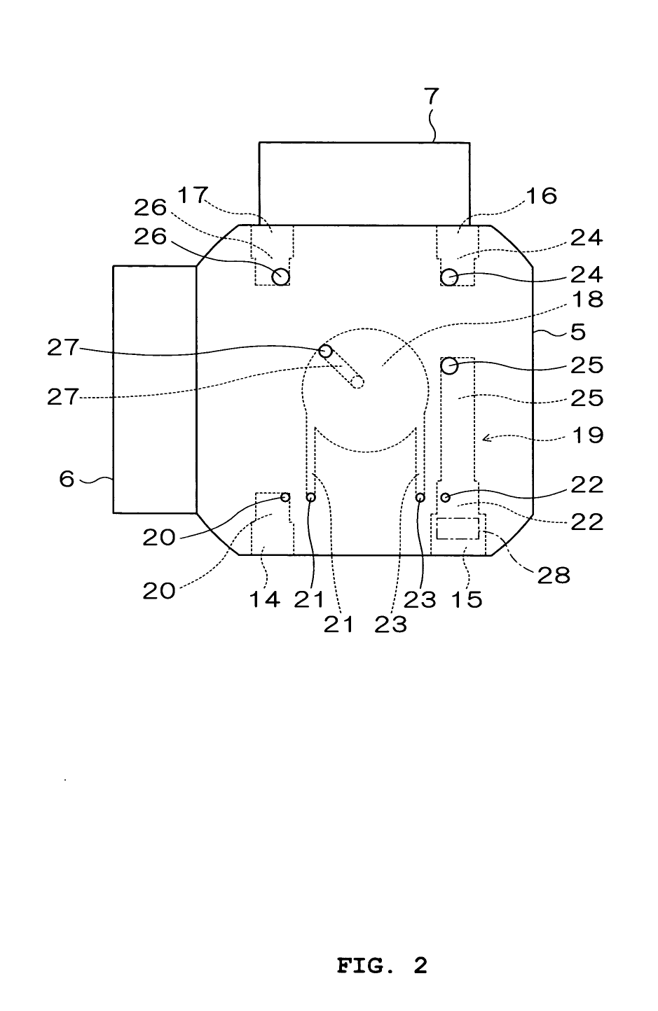

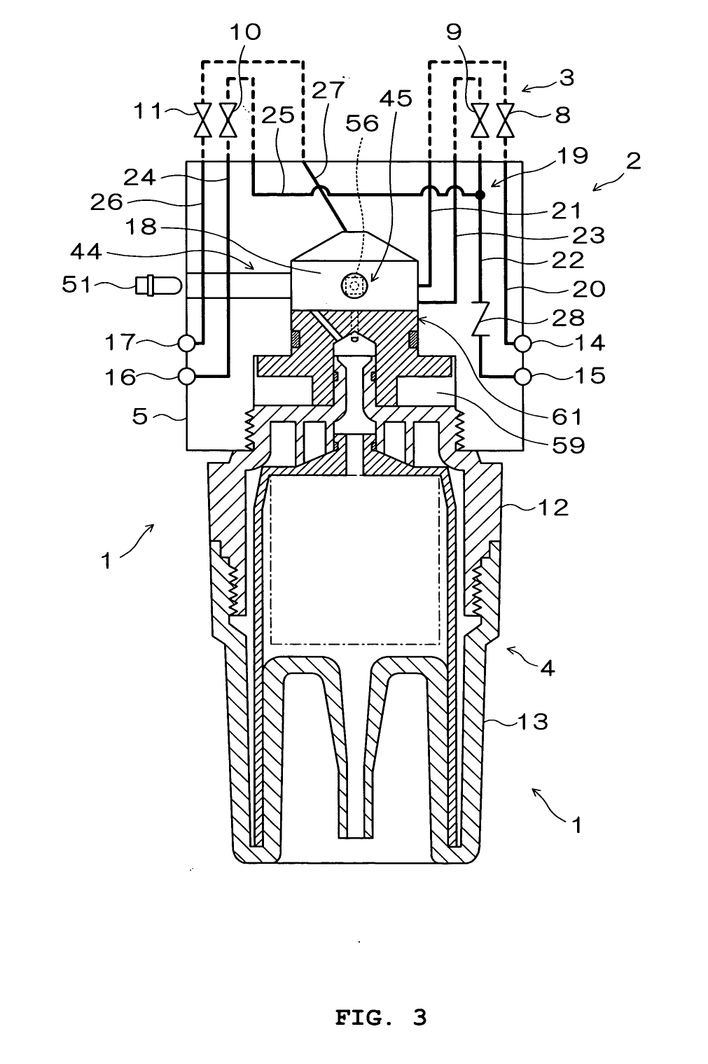

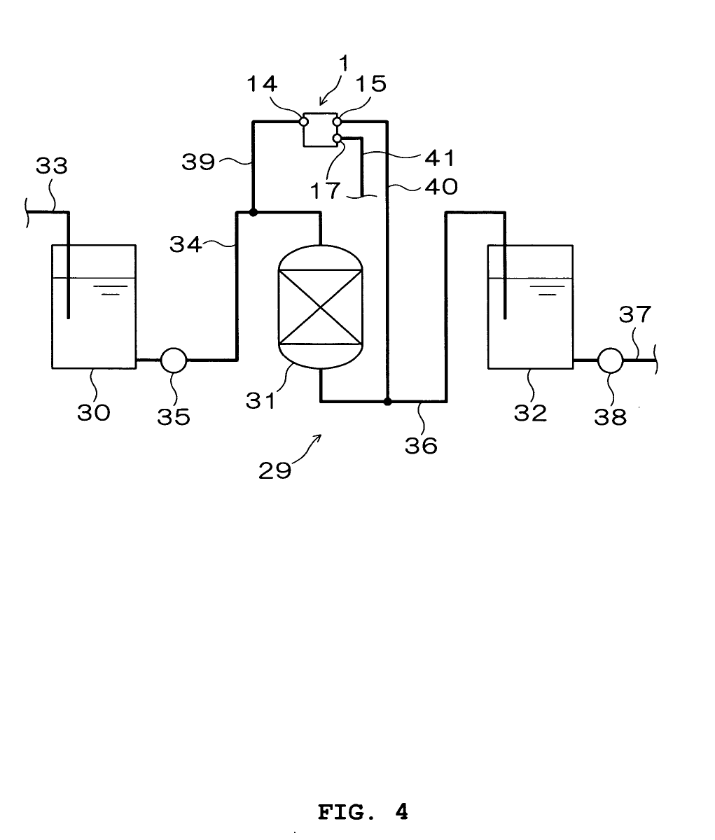

In the following, the first embodiment of the present invention will be described in detail with reference to the drawings. FIG. 1 is a full view of a turbidity measuring device to which an optical measuring device according to the present invention is applied. FIG. 2 is a sectional view taken along the line II-II of FIG. 1. FIG. 3 is a view showing a liquid flow in the turbidity measuring device. FIG. 4 shows a filtering system to which the turbidity measuring device is connected. A turbidity measuring device 1 of FIG. 1 can effect switching in the introduction of a plurality of sample waters, making it possible to measure the turbidity of each of them, and is equipped with a measuring section 2, a flow control section 3, and a filtering section 4.

The measuring section 2 is a section for measuring 90° scattered light of water sample. The measuring section 2 is mainly equipped with a measuring cell 5, a first casing member 6, and a second casing member 7. The flow control section 3 is a section for controlling the introduction of sample water, the introduction of raw water for producing clean water, the discharge of sample water, or the discharge of clean water. The flow control section 3 is equipped with a first valve 8, a second valve 9, a third valve 10, and a fourth valve 11 that are attached to the top portion of the measuring cell 5. There are no particular limitations regarding the valves 8, 9, 10, and 11 as long as they can control the flow of a fluid; for example, it is possible to use various valve mechanisms, such as electromagnetic valves or motor valves. The filtering section 4 is a section for producing clean water from raw water. The filtering section 4 is mainly equipped with a first filter casing 12, which is connected to the lower portion of the measuring cell 5, and a second filter casing 13.

On the front side of the measuring cell 5, there are provided a first sample water inlet 14 for introducing a first sample water, and a second sample water inlet 15 for introducing a second sample water. On the rear side of the measuring cell 5, there are provided a sample water outtake 16 for supplying the second sample water to the filtering section 4 to produce clean water therefrom, and a drainage outlet 17 for discharging sample water or clean water out of the measuring cell 5. A joint (not shown), such as a tube fitting, is mounted to each of the first sample water inlet 14, the second sample water inlet 15, the sample water outtake 16, and the drainage outlet 17, making it possible to easily connect a predetermined sampling line, drainage line, etc. The first casing member 6 is attached to the left-hand surface of the measuring cell 5, and a light emitting element is accommodated in the first casing member 6. On the other hand, the second casing member 7 is attached to the rear surface of the measuring cell 5, and a light receiving element is accommodated in the second casing member 7.

As shown in FIGS. 2 and 3, a measuring chamber 18 for storing sample water is formed in the measuring cell 5. Further, in the measuring cell 5, a flow passage section 19 for guiding sample water into or out of the measuring chamber 18 is formed. The flow passage section 19 is composed of a first flow passage 20, a second flow passage 21, a third flow passage 22, a fourth flow passage 23, a fifth flow passage 24, a sixth flow passage 25, a seventh flow passage 26, and an eighth flow passage 27. To be more specific, the first flow passage 20 is formed in an L-shaped configuration so as to extend from the first sample water inlet 14 to the upper surface of the measuring cell 5. The second flow passage 21 is formed in an L-shaped configuration so as to extend from the inner peripheral surface of the measuring chamber 18 to the upper surface of the measuring cell 5. The first flow passage 20 and the second flow passage 21 are opened or closed by the first valve 8. The third flow passage 22 is formed in an L-shaped configuration so as to extend from the second sample water inlet 15 to the upper surface of the measuring cell 5. The fourth flow passage 23 is formed in an L-shaped configuration so as to extend from the inner peripheral surface of the measuring chamber 18 to the upper surface of the measuring cell 5. The third flow passage 22 and the fourth flow passage 23 are opened or closed by the second valve 9. Further, on the second sample water inlet 15 side, a check valve 28 is provided in the third flow passage 22.

The fifth flow passage 24 is formed in an L-shaped configuration so as to extend from the sample water outtake 16 to the upper surface of the measuring cell 5. The sixth flow passage 25 is formed in an L-shaped configuration so as to communicate with the third flow passage 22 and to extend to the upper surface of the measuring cell 5. The fifth flow passage 24 and the sixth flow passage 25 are opened or closed by the third valve 10. The seventh flow passage 26 is formed in an L-shaped configuration so as to extend from the drainage outlet 17 to the upper surface of the measuring cell 5. The eighth flow passage 27 is formed so as to extend at a predetermined angle from the top portion of the measuring chamber 18 to the upper surface of the measuring cell 5. The seventh flow passage 26 and the eighth flow passage 27 are opened or closed by the fourth valve 11.

To monitor the filtering performance of various filtering apparatuses, the turbidity measuring device 1 to be used is incorporated, for example, into a filtering system as shown in FIG. 4. In FIG. 4, a filtering system 29 is mainly equipped with a raw water tank 30, a filtering apparatus 31, and a treated water tank 32. The raw water tank 30 is connected to a water supply source (not shown), such as a well, through a raw water supply line 33. Further, the raw water tank 30 is connected to the filtering apparatus 31 through a raw water feed line 34. A raw water feed pump 35 is provided in the raw water feed line 34. The treated water tank 32 is connected to the filtering apparatus 31 through a treated water supply line 36. Further, the treated water tank 32 is connected to a use point (not shown) through a treated water feed line 37. A treated water feed pump 38 is provided in the treated water feed line 37.

To introduce raw water before being supplied to the filtering apparatus 31 and treated water having passed through the filtering apparatus 31, the turbidity measuring device 1 is connected to the raw water feed line 34 and the treated water supply line 36 through a raw water sampling line 39 and a treated water sampling line 40, respectively. That is, the raw water sampling line 39 is connected to the first sample water inlet 14, and the treated water sampling line 40 is connected to the second sample water inlet 15. Further, a drain line 41 extending to a drain pit (not shown) is connected to the drainage outlet 17.

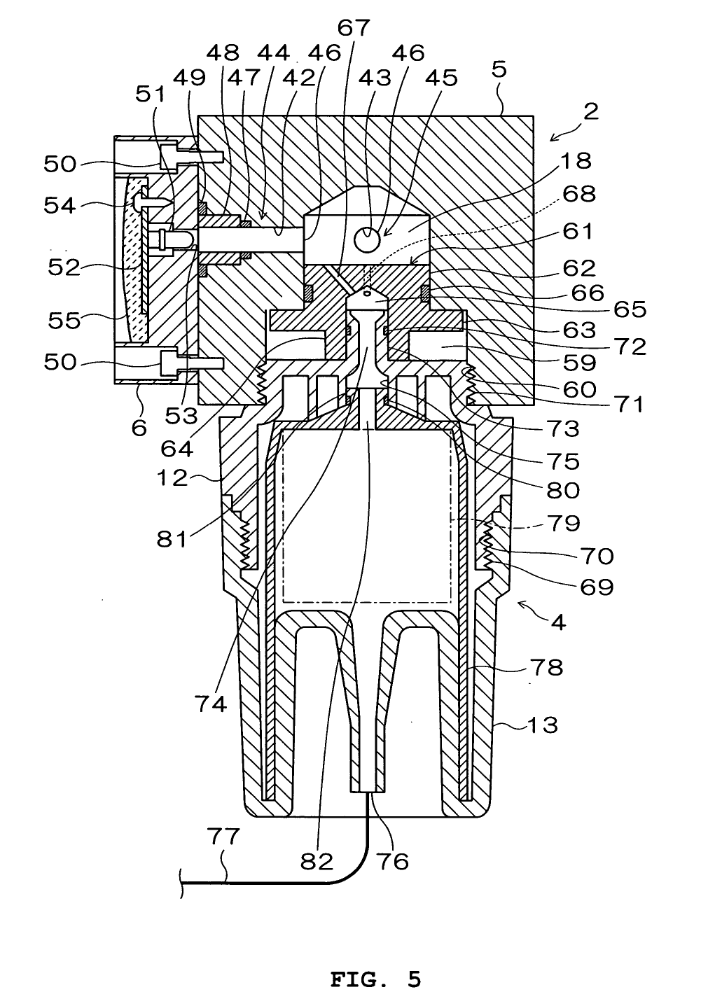

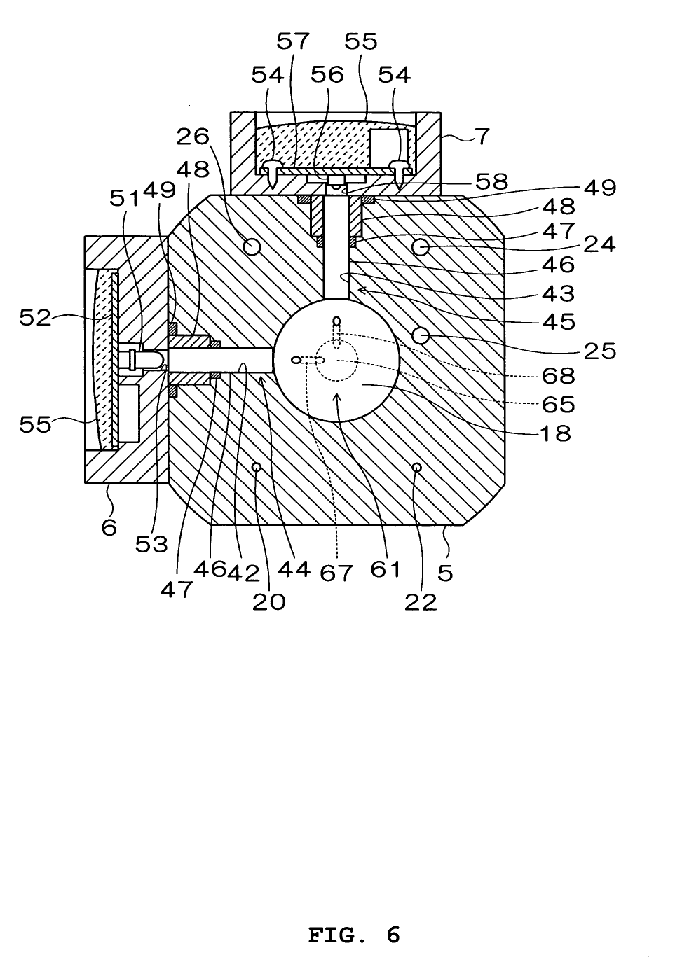

Next, the construction of the turbidity measuring device 1 will be described in more detail with reference to FIGS. 5 and 6. FIG. 5 is a longitudinal sectional view of the measuring section 2 and the filtering section 4. FIG. 6 is a sectional view taken along the line V-V of FIG. 1. The measuring cell 5 has the measuring chamber 18, and, from the viewpoint of preventing generation of reflected light and stray light in the measuring cell 5, is formed of a non-light-transmitting material (e.g., a plastic material colored in black or a stainless steel material painted in black).

The measuring cell 5 is equipped with a first perforated path 42 and a second perforated path 43 that extend horizontally from the outside into the measuring chamber 18. The axes of the perforated paths 42 and 43 are orthogonal to each other in the same plane. A first light guide portion 44 and a second light guide portion 45 are fitted into the perforated paths 42 and 43, respectively, from the outer side of the measuring cell 5. Each of the light guide portions 44 and 45 is formed by attaching a first seal member 47 and a hold member 48 to a transparent rod 46. Further, on the outer surface side of the measuring cell 5, a second seal member 49 is attached to the hold member 48. That is, in each of the perforated paths 42 and 43, there are provided step portions (not indicated by reference numerals) corresponding to the first seal member 47, the hold member 48, and the second seal member 49.

The transparent rod 46 is a member functioning as a light transmitting window, and is formed, for example, by machining a round rod of quartz glass having an outer diameter of 3 to 10 mm. The transparent rod 46 is set to a predetermined length (e.g., 20 to 50 mm) so as to reach the measuring chamber 18 from the outer surface of the measuring cell 5, and the end portions thereof are polished into smooth vertical surfaces perpendicular to the axis. The first seal member 47 is an annular packing, such as an O-ring, and is attached to a position on the transparent rod 46 near the center thereof. The hold member 48 is a cylindrical member for preventing detachment of the first seal member 47, and one end thereof is set to be long enough to reach the outer surface of the measuring cell 5. The second seal member 49 is an annular packing, such as an O-ring.

The first light guide portion 44 fitted into the first perforated path 42 is sealed by the first casing member 6 from the outer side of the measuring cell 5. To be more specific, the light emitting side surface of the first casing member 6 is held in contact with the second seal member 49 on the side of the first light guide portion 44, and the first casing member 6 is held in intimate contact with the measuring cell 5 by bolts 50. In this state, the space between the first perforated path 42 and the transparent rod 46 is kept liquid-tight and airtight through the first seal member 47 fixed at a predetermined position by the hold member 48. Further, detachment of the transparent rod 46 and the hold member 48 due to the inner pressure from the measuring chamber 18 is prevented by holding their end surfaces situated on the outer surface side of the measuring cell 5 in intimate contact with the light emitting side surface of the first casing member 6.

The second light guide portion 45 fitted into the second perforated path 43 is sealed from the outer side of the measuring cell 5 by the second casing member 7. To be more specific, the light receiving side surface of the first casing member 7 is held in contact with the second seal member 49 on the side of the second light guide portion 45, and the second casing member 7 is held in intimate contact with the measuring cell 5 by bolts (not shown). In this state, the space between the second perforated path 43 and the transparent rod 46 is kept liquid-tight and airtight through the first seal member 47 fixed at a predetermined position by the hold member 48. Further, detachment of the transparent rod 46 and the hold member 48 due to the inner pressure from the measuring chamber 18 is prevented by holding their end surfaces situated on the outer surface side of the measuring cell 5 in intimate contact with the light receiving side surface of the second casing member 7.

In the first casing member 6, there is accommodated a light emitting circuit board 52 to which a light emitting element 51 (e.g., an LED) is attached. To be more specific, at the position of the first casing member 6 corresponding to the transparent rod 46, there is provided a first perforated hole 53, in which the light emitting element 51 is accommodated. Here, the diameter of the first perforated hole 53 is set to be smaller than the outer diameter of the transparent rod 46. The light emitting circuit board 52 is fixed in position within the first casing member 6 by a screw 54. The light emitting circuit board 52 is sealed in the first casing member 6 by filling the casing member with a resin material 55. In this state, the light emitting element 51 is isolated from the outside by being accommodated in the first perforated hole 53, and is tightly sealed in the first casing member 6 by the second seal member 49 and the resin material 55.

On the other hand, in the second casing member 7, there is accommodated a light receiving circuit board 57 to which a light receiving element 56 (e.g., a photodiode) is attached. To be more specific, at the position of the second casing member 7 corresponding to the transparent rod 46, there is provided a second perforated hole 58, in which the light receiving element 56 is accommodated. Here, the diameter of the second perforated hole 58 is set to be smaller than the outer diameter of the transparent rod 46. The light receiving circuit board 57 is fixed in position within the second casing member 7 by the screws 54. The light receiving circuit board 57 is sealed in the second casing member 7 by filling the casing member with the resin material 55. In this state, the light receiving element 56 is isolated from the outside by being accommodated in the second perforated hole 58, and is tightly sealed in the second casing member 7 by the second seal member 49 and the resin material 55.

In the lower portion of measuring chamber 18, there is provided an intermediate chamber 59 open in the lower surface of the measuring cell 5. The diameter of the intermediate chamber 59 is set to be larger than that of the measuring chamber 18. In the lower portion of the intermediate chamber 59, there is formed a first female screw portion 60 for connecting the filtering section 4. That is, the intermediate chamber 59 constitutes a communicating portion between the measuring chamber 18 and the filtering section 4, and a nozzle 61 is arranged in the communicating portion. The nozzle 61 is equipped with a cylindrical nozzle body 62 and a flange portion 63 and a support portion 64 provided under the nozzle body 62. Formed in the nozzle body 62 is a clean water supply chamber 65 open in the lower surface of the support portion 64. The nozzle 61 is retained within the measuring cell 5 by inserting the nozzle body 62 into the measuring chamber 18 through a third seal member 66, such as an O-ring, bringing the flange portion 63 into contact with the step portion (not indicated by a reference numeral) between the measuring chamber 18 and the intermediate chamber 59, and then supporting the lower surface of the support portion 64 by the upper surface of the first filter casing 12.

The nozzle 61 is equipped with a first nozzle hole 67 and a second nozzle hole 68 that extend from the interior of the clean water supply chamber 65 to the upper surface of the nozzle body 62. The first nozzle hole 67 is set at an angle such that the center line thereof passes through the center of the end surface of the transparent rod 46 on the first light guide portion 44 side. The second nozzle hole 68 is set at an angle such that the center line thereof passes through the center of the end surface of the transparent rod 46 on the second light guide portion 45 side. Each of the first nozzle hole 67 and the second nozzle hole 68 is set to have a hole diameter such that clean water is ejected at a predetermined flow velocity (e.g. in the range of 4 to 11 m/s when the water pressure in the clean water supply chamber 65 is 0.1 to 0.49 MPa).

The first filter casing 12 and the second filter casing 13 are hollow members accommodating filter cartridges to be described below. The filter casings 12 and 13 form an integral container through connection of a first male screw portion 69 formed on the lower portion of the filter casing 12 with a second female screw portion 70 formed on the upper portion of the second filter casing 13. A second male screw portion 71 is formed on the upper portion of the first filter casing 12; by connecting the second male screw portion 71 with the first female screw portion 60, the filtering section 4 and the measuring cell 5 are connected to each other.

On the upper surface of the first filter casing 12, there is provided a cylindrical first projecting portion 73 to which a fourth seal member 72, such as an O-ring, is attached. The first projecting portion 73 is fitted into the clean water supply chamber 65. A first hollow portion 74 of the first projecting portion 73 communicates with a connection hole 75 formed in the first filter casing 12. In the lower portion of the second filter casing 13, there is provided a sample water intake 76 for introducing raw water (that is, the second sample water) from the sample water outtake 16 into the filtering section 4. Here, the sample water intake 76 is connected to the sample water outtake 16 through a sample water supply line 77, such as a tube.

A filter cartridge 78 is accommodated in the container formed by the filter casings 12 and 13. The filter cartridge 78 is formed in a reverse-cup-like configuration, and contains a filter medium 79, such as a hollow fiber filter or a string wound filter. At the top portion of the cartridge 78, there is provided a cylindrical second projecting portion 81 to which a fifth seal member 80, such as an O-ring, is attached, and the second projecting portion 81 is fitted into the connection hole 75. Here, a second hollow portion 82 of the second projecting portion 81 communicates with the transmission side of the filter medium 79. That is, the raw water introduced from the sample water intake 76 is purified by the filter medium 79, and then supplied into the clean water supply chamber 65 through the second hollow portion 82 and the first hollow portion 74. In this construction, the clean water produced in the filtering section 4 is supplied directly to the nozzle 61 without passing through supply piping. Thus, the clean water from the filtering section 4 reaches the nozzle 61 without undergoing a reduction in pressure, so it is possible to maintain the flow velocity of the clean water ejected against the light guide portions 44 and 45 within a predetermined range.

In order to maintain the filtering capacity of the filter medium 79, the filter cartridge 78 is periodically replaced (when, for example, the number of times that the measuring operation to be described below is performed reaches a predetermined value). The used filter cartridge 78 can be easily extracted by separating the second filter casing 13 from the first filter casing 12. Conversely, the new filter cartridge 78 can be easily incorporated by fitting the second projecting portion 81 into the connection hole 75 and connecting the second filter casing 13 to the first filter casing 12.

The valves 8, 9, 10, and 11, the light emitting circuit board 52, and the light receiving circuit board 57 are each connected to a controller (not shown), and are operated in accordance with a command signal from the controller.

In the above-mentioned construction, in the turbidity measuring device 1, the flow control section 3 and the flow passage section 19, which constitute a sample water sampling mechanism, and the filtering section 4, which constitutes a clean water producing mechanism, are integrally incorporated together with the measuring section 2, so the requisite space for installation is fairly small. Further, the turbidity measuring device 1 can be used solely by being connected to the raw water sampling line 39, the treated water sampling line 40, and the drain line 41.

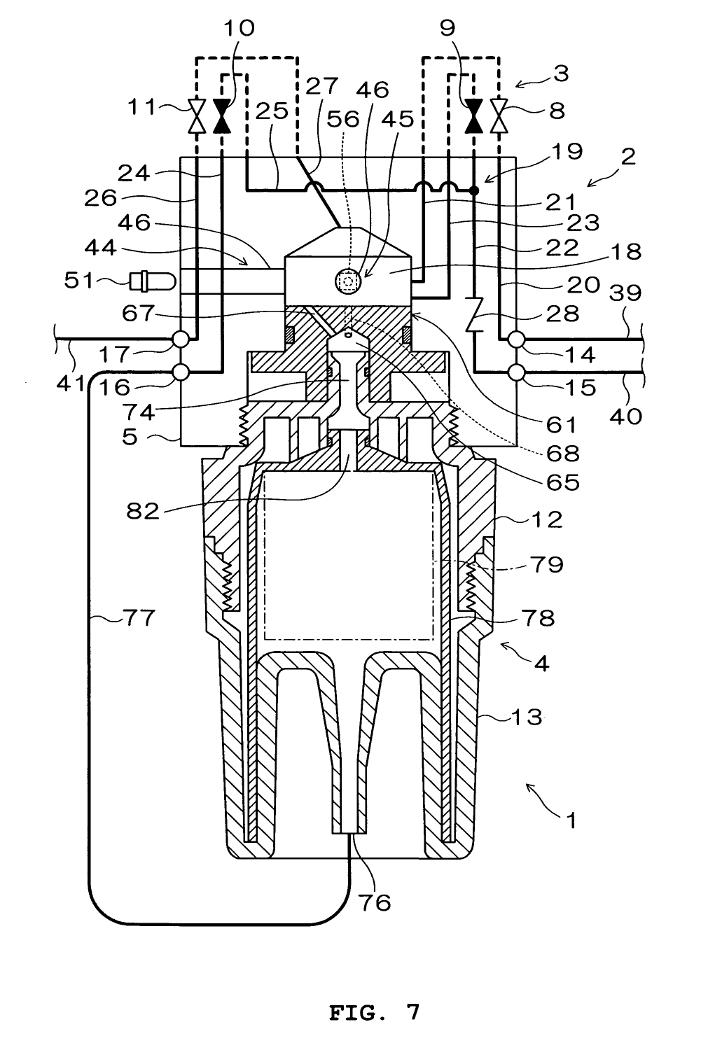

In the following, the measuring operation of the turbidity measuring device 1 according to the first embodiment of the present invention will be described in detail with reference to FIGS. 7 through 9. For every predetermined measuring interval time (e.g., 30 minutes to 6 hours) set for the controller (not shown), the turbidity measuring device 1 performs a series of measuring operations, more specifically, a first measuring process, a second measuring process, and a washing process in that order.

As shown in FIG. 7, in the first measuring process, the first valve 8 and the fourth valve 11 are set in the open state in accordance with the command signal from the controller. On the other hand, the second valve 9 and the third valve 10 are set in the closed state. The raw water flowing through the raw water sampling line 39 (that is, the raw water before being supplied to the filtering apparatus 31) is introduced into the measuring chamber 18 from the first sample water inlet 14 through the first flow passage 20 and the second flow passage 2l. The raw water flows from the upper portion of the measuring chamber 18 to the drainage outlet 17 through the eighth flow passage 27 and the seventh flow passage 26 while extruding the clean water stored in the measuring chamber 18 in the previous washing process. Then, the water from the drainage outlet 17 is continuously discharged to the exterior of the system through the drain line 41. When a lift type valve is used as the second valve 9, raw water containing a suspended substance may leak from the raw water sampling line 39, which is on the high pressure side, to the treated water sampling line 40, which is on the low pressure side; however, due to the action of the check valve 28, it is possible to prevent raw water from being mixed into treated water.

When a predetermined period of time (e.g., 30 seconds to 5 minutes) during which the clean water in the measuring chamber 18 is totally replaced by raw water, has elapsed, the first valve 8 and the fourth valve 11 are set in the closed state. As a result, a predetermined amount of raw water is stored in the measuring chamber 18 as the sample water. Next, light from the light emitting element 51 is applied to the sample water in the measuring chamber 18 through the first light guide portion 44, and 90° scattered light from the sample water is detected by the light receiving element 56 through the second light guide portion 45. Then, the intensity of the scattered light at this time is stored in a memory in the controller as a measurement value (A). When the measurement value (A) is obtained, the procedure for the turbidity measuring device 1 advances to the second measuring process.

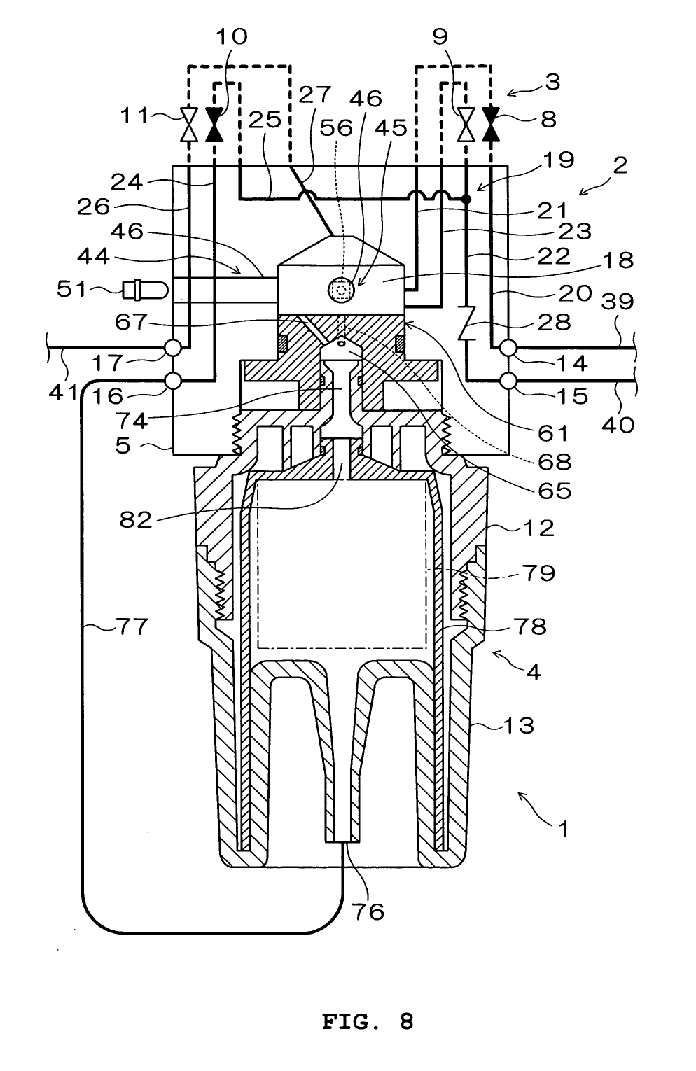

As shown in FIG. 8, in the second measuring process, the second valve 9 and the fourth valve 11 are set in the open state in accordance with the command signal from the controller. On the other hand, the first valve 8 and the third valve 10 are set in the closed state. The treated water flowing through the treated water sampling line 40 (that is, the treated water having passed through the filtering apparatus 31) is introduced into the measuring chamber 18 from the second sample water inlet 15 through the third flow passage 22 and the fourth flow passage 23. The treated water flows from the upper portion of the measuring chamber 18 to the drainage outlet 17 through the eighth flow passage 27 and the seventh flow passage 26 while extruding the raw water stored in the measuring chamber 18 in the first measuring process. Then, the water from the drainage outlet 17 is continuously discharged to the exterior of the system through the drain line 41.

When a predetermined period of time (e.g., 30 seconds to 5 minutes) during which the raw water in the measuring chamber 18 is totally replaced by treated water, has elapsed, the second valve 9 and the fourth valve 11 are set in the closed state. As a result, a predetermined amount of treated water is stored in the measuring chamber 18 as the sample water. Next, light from the light emitting element 51 is applied to the sample water in the measuring chamber 18 through the first light guide portion 44, and 90° scattered light from the sample water is detected by the light receiving element 56 through the second light guide portion 45. Then, the intensity of the scattered light at this time is stored in memory in the controller as a measurement value (B). When the measurement value (B) is obtained, the procedure for the turbidity measuring device 1 advances to the washing process.

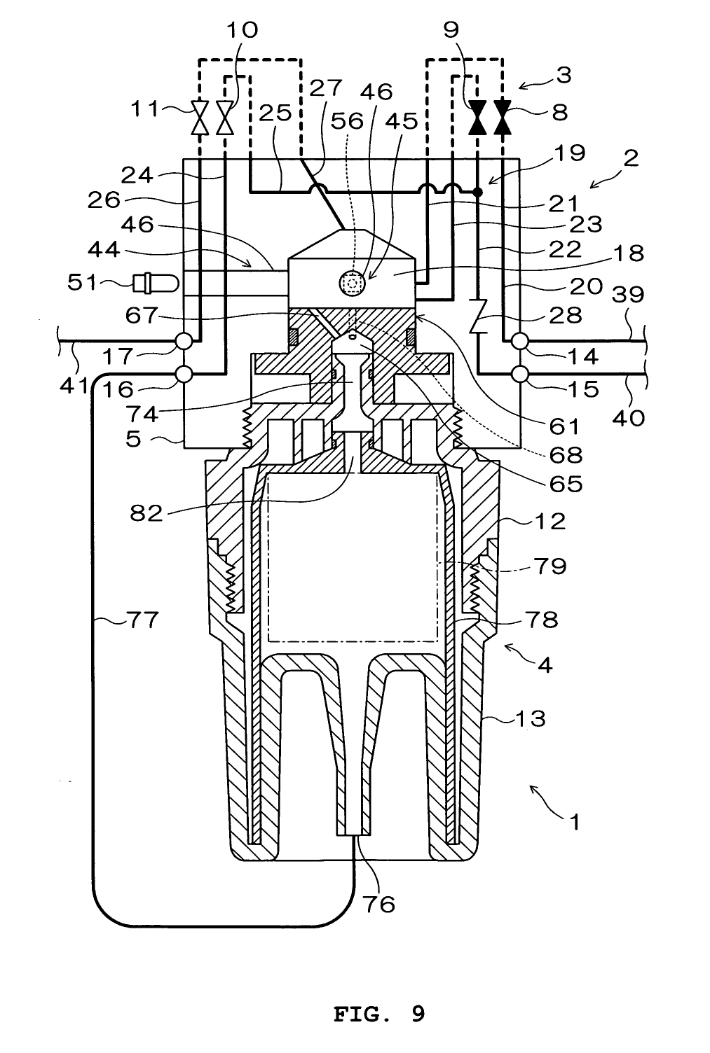

As shown in FIG. 9, in the washing process, the third valve 10 and the fourth valve 11 are set in the open state in accordance with the command signal from the controller. On the other hand, the first valve 8 and the second valve 9 are set in the closed state. The treated water flowing through the treated water sampling line 40 (that is, the treated water having passed through the filtering apparatus 31) is supplied from the second sample water inlet 15 to the sample water outtake 16 through the third flow passage 22, the sixth flow passage 25, and the fifth flow passage 24 as the raw water for producing clean water. Further, this raw water is supplied to the sample water intake 76 through the sample water supply line 77, and introduced into the filter cartridge 78. In the filter cartridge 78, clean water is produced by passing the raw water through the filter medium 79. This clean water is supplied into the clean water supply chamber 65 through the second hollow portion 82 and the first hollow portion 74, and then injected into the measuring chamber 18 through the nozzle 61 as washing water.

The washing water ejected from the first nozzle hole 67 at a predetermined flow velocity hits the end surface of the transparent rod 46 on the first light guide portion 44 side, and washes away a contaminant component allowed to adhere thereto in the measuring processes while separating it therefrom. On the other hand, the washing water ejected from the second nozzle hole 68 at a predetermined flow velocity hits the end surface of the transparent rod 46 on the second light guide portion 45 side, and washes away the contaminant component allowed to adhere thereto in the measuring processes while separating it therefrom. Thus, the contamination of the end surfaces of the transparent rods 46 is suppressed, and a predetermined measuring accuracy is maintained. The used cleansing water flows from the upper portion of the measuring chamber 18 to the drainage outlet 17 through the eighth flow passage 27 and the seventh flow passage 26, and is continuously discharged to the exterior of the system through the drain line 41.

When the washing of the transparent rods 46 is executed for a predetermined period of time (e.g., 30 seconds to 5 minutes), the third valve 10 and the fourth valve 11 are set in the closed state. As a result, a predetermined amount of clean water is stored in the measuring chamber 18 as blank water. Next, light from the light emitting element 51 is applied to the blank water in the measuring chamber 18 through the first light guide portion 44, and 90° scattered light from the blank water is detected by the light receiving element 56 through the second light guide portion 45. The intensity of the scattered light at this time is stored in the memory as a blank value (C). When the blank value (C) is obtained, the turbidity measuring device 1 performs a judgment processing on the turbidity of the raw water and the treated water.

First, in the controller, the measurement value (A) and the blank value (C) are read out of the memory, and the difference (A-C) in scattered light intensity is obtained; then, the turbidity of the raw water is judged from the value of the difference (A-C) based on a previously stored analytical curve. Next, in the controller, the measurement value (B) and the blank value (C) are read out of the memory, and the difference (B-C) in scattered light intensity is obtained; then, the turbidity of the treated water is judged from the value of the difference (B-C) based on the analytical curve. That is, in this judgment processing, the measurement value (A) and the measurement value (B) are corrected by the blank value (C), whereby the zero-point drift generated due to fluctuations in ambient temperature, etc. is canceled, thereby achieving an enhancement in judgment accuracy. The judged turbidity of the raw water and that of the treated water are output, for example, to a display (not shown). When the turbidity of the raw water and that of the treated water have been output, the turbidity measuring device 1 is kept on standby until the next measuring operation. Here, during standby of the turbidity measuring device 1, clean water is kept stored in the measuring chamber 18, so adhesion of the contaminant component to the transparent rods 46 is suppressed, and a predetermined measuring accuracy is maintained.

According to the first embodiment of the present invention described above, it is possible to realize a compact optical measuring device in which the sample water sampling mechanism and the clean water producing mechanism are integrated with each other. Further, there is realized an optical measuring device capable of performing nozzle-washing without involving a reduction in the pressure with which clean water is supplied. As a result, it is possible to perform installation on-site and maintenance in a short period of time. Further, it is possible to effectively remove a contaminant component adhering to the light transmitting windows, making it possible to maintain a predetermined measuring accuracy.

### Second Embodiment

In the optical measuring device of the first embodiment of the present invention described above, turbidity is measured from the 90° scattered light of the sample water. However, the optical measuring device according to the present invention may also adopt a construction in which the first light guide portion 44 and the second light guide portion 45 are arranged at a predetermined angle other than 90°, whereby it is possible to measure turbidity from, for example, 45° scattered light or 135° scattered light of the sample water. Further, it is also possible for the optical measuring device according to the present invention to adopt a construction in which the first light guide portion 44 and the second light guide portion 45 are arranged to be opposed to each other, whereby turbidity measurement is effected from the transmitted light of the sample water.

### Third Embodiment

In the first and second embodiments of the present invention described above, the optical measuring device measures the turbidity of the sample water. However, the optical measuring device according to the present invention is also applicable to the measurement of the concentration of a specific component of the sample water, for example, the concentration of a hardness component, dissolved oxygen, residual chlorine, whole chlorine, alkali component, hydrogen ions (pH), or silica by a calorimetric method using a coloring reagent. In this case, the first light guide portion 44 and the second light guide portion 45 are usually arranged to be opposed to each other to detect the transmitted light of a sample water. Further, a chemical supply device is connected to the measuring cell 5 so that a chemical containing a coloring reagent can be added to the sample water in the measuring chamber 18. Further, it is also desirable to provide the measuring cell 5 with an agitating device in order to uniformly mix the sample water and chemicals with each other.

What is claimed is:

1. An optical measuring device which applies light from a light emitting element to a sample solution in a measuring chamber provided in a measuring cell through a first light guide portion and which detects light from the sample solution by a light receiving element through a second light guide portion, the optical measuring device comprising:
a flow passage section formed in the measuring cell and adapted to guide the sample solution into or out of the measuring chamber;
a flow control section attached to the measuring cell and serving to open and close the flow passage section; and
a filtering section connected to the measuring cell and communicating with the measuring chamber.

2. An optical measuring device according to claim 1, wherein a nozzle for ejecting a cleaning fluid from the filtering section against the first light guide portion and the second light guide portion is provided in a communicating portion between the measuring chamber and the filtering section.
